(19) United States
(12) Patent Application Publication
(10) Pub. No.: US 2025/0023430 A1
(43) Pub. Date: Jan. 16, 2025

(54) MOTOR

(71) Applicant: LG INNOTEK CO., LTD., Seoul (KR)

(72) Inventor: Byung Sam LEE, Seoul (KR)

(73) Assignee: LG INNOTEK CO., LTD., Seoul (KR)

(21) Appl. No.: 18/714,480

(22) PCT Filed: Nov. 16, 2022
(86) PCT No.: PCT/KR2022/018142

§ 371 Date: May 29, 2024

(30) Foreign Application Priority Data
Dec. 15, 2021 (KR) 10-2021-0179513

(51) Int. Cl. H02K 11/215; H02K 1/274

(52) U.S. Cl. CPC H02K 11/215; H02K 1/274

(57) ABSTRACT

A motor comprising: a stator; a rotor disposed inside the stator; a shaft coupled to the rotor; and a sensing magnet disposed above the rotor, wherein the sensing magnet is provided with a plurality of radial slots.

### TECHNICAL FIELD

The present embodiment relates to a motor.

### BACKGROUND ART

A motor is a device that converts electrical energy into rotational energy by using the force a conductor receives in a magnetic field. Recently, as the use of motors has expanded, the role of motors has become more important. In particular, as the electrification of automobiles progresses rapidly, the demand for motors being applied to steering systems, braking systems, and design systems is increasing significantly.

Typically, a motor is provided with a rotating shaft, a rotor being coupled to the rotating shaft, a magnet being coupled to the rotor, and a stator being fixed to the inside of the housing, wherein the stator is installed with a gap along the circumference of the rotor. Additionally, a coil that forms a rotating magnetic field is wound around the stator, causing electromagnetic interaction with the magnet to induce rotation of the rotor. Therefore, as the rotor rotates, the rotating shaft rotates and generates driving force.

Meanwhile, the motor includes a position detection sensor to detect the rotational position of the rotor or rotation shaft. The position detection sensor includes a sensing magnet being coupled to the outside of a shaft and a sensor facing the sensing magnet. Therefore, it is a structure in which the position of the rotor or shaft is detected by the sensor detecting the magnetic field of the sensing magnet.

However, the motor according to the prior art has a problem in that the pole splitting inside the sensing magnet is not uniform, and the sensing sensitivity is formed differently depending on the position of the sensing magnet, thereby deteriorating the performance of the motor.

### DETAILED DESCRIPTION OF THE INVENTION

### Technical Subject

The present embodiment is intended to provide a motor with enhanced sensing sensitivity and easy position detection by uniformly forming pole splitting in all regions inside the sensing magnet.

### Technical Solution

A motor according to the present embodiment comprises: a stator; a rotor being disposed inside the stator; a shaft being coupled to the rotor; and a sensing magnet being disposed above the rotor, wherein the sensing magnet is provided with a plurality of radial slots.

The sensing magnet may be coupled to a support plate, and the support plate may be coupled to the shaft.

It may include a cover being coupled to the support plate to cover the other surface of the sensing magnet.

The support plate includes one surface facing the rotor and the other surface facing the cover, wherein the other surface of the support plate includes a protruded region being more protruded than the other region, and wherein the sensing magnet may be disposed outside the protruded region.

The sensing magnet may include one surface facing the rotor, and the slot may be formed on the other surface of the sensing magnet facing the one surface.

The sensing magnet includes a base portion and a plurality of protruded portions being protruded from the base portion, and the slot may be disposed between the pluralities of protruded portions.

The length of the slot in a radial direction may be equal to or smaller than the length of the base portion in a radial direction.

The length of the slot in a radial direction may correspond to the length of the base portion in a radial direction.

The length of the slot in a circumferential direction may be smaller than the length of the protruded portion in a circumferential direction.

The slot may be disposed on an outer circumferential surface of the sensing magnet.

### Advantageous Effects

Through the present embodiment, the magnetic field in each region of the sensing magnet can be formed uniformly by forming a polarization structure between regions with different polarities through slots, and accordingly, there is an advantage that the sensing sensitivity of the sensor according to the driving of the motor can be enhanced.

### BRIEF DESCRIPTION OF DRAWINGS

FIG. 1 is a perspective view of a motor according to an embodiment of the present invention.

FIG. 2 is a plan view of a sensing magnet according to a first embodiment of the present invention.

FIG. 3 is a plan view of a sensing magnet according to a second embodiment of the present invention.

FIG. 4 is a diagram illustrating the magnetic pole deviation for each region of a sensing magnet according to the prior art.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction based on one component may be included.

Hereinafter, the present invention will be described in more detail with reference to the attached drawings.

A motor according to the invention can be disposed inside a vehicle.

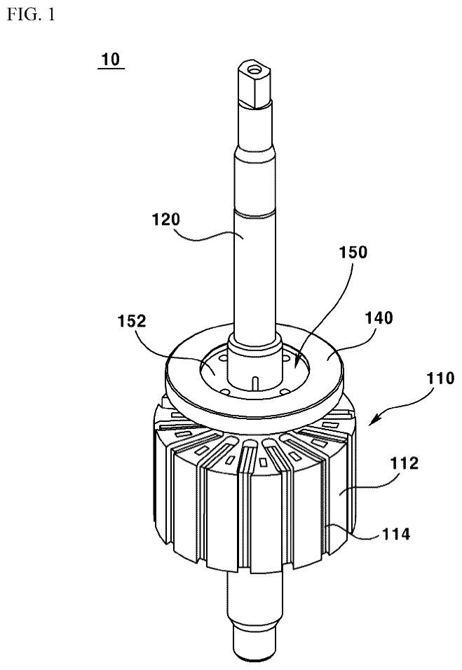

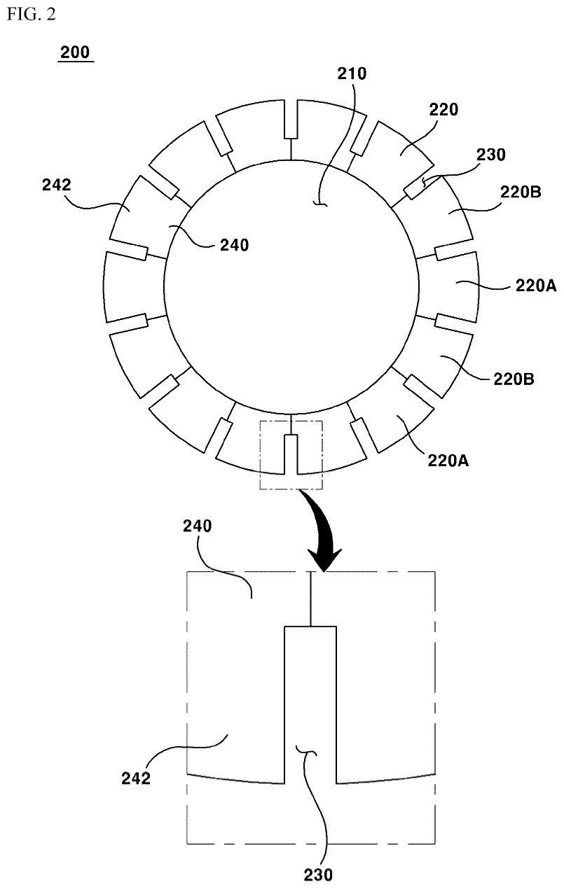

FIG. 1 is a perspective view of a motor according to an embodiment of the present invention; and FIG. 2 is a plan view of a sensing magnet according to a first embodiment of the present invention.

Referring to FIGS. 1 and 2, the motor 10 according to an embodiment of the present invention may include a housing, a stator, a rotor 110, a shaft 120, and a sensing magnet 200.

The housing (not shown) forms the outer shape of the motor 10 and may include a space therein for accommodating components inside the motor 10. A hole through which the shaft 120 penetrates may be formed on an outer surface of the housing.

The stator (not shown) may be disposed inside the housing. The stator may include a stator core, an insulator surrounding an outer surface of the stator core, and a coil being wound around the insulator.

The rotor 110 may be disposed inside the stator. The rotor 110 may include a rotor core 112 and a magnet 114 being seated on the rotor core 112. The magnet 114 is disposed to face the coil, and the rotor 110 and the shaft 120 can rotate together due to electromagnetic interaction between the magnet 114 and the coil. A hole into which the shaft 120 is coupled may be formed in the center of the rotor core 112.

The shaft 120 may be disposed in the center of the rotor 110. The shaft 120 may rotate together with the rotor 110.

A sensing magnet 200 may be disposed on an outer surface of the shaft 120. The sensing magnet 200 may be disposed on an outer surface of the shaft 120 being spaced apart from the rotor 110 by a predetermined distance in an axial direction.

The motor 10 may include a support plate 150 and a cover 140, wherein the sensing magnet 200 is disposed on the support plate 150, and wherein the cover 140 may be coupled to an upper portion of the support plate 150 to cover the upper surface of the sensing magnet 200. The support plate 150 includes a hole in the center through which the shaft 120 penetrates, and may have a plate shape. A protruded region 152 being protruded more upward than other regions may be formed at the central area of the support plate 150. The sensing magnet 200 is disposed outside the protruded region 152, and the cover 140 may be coupled to the support plate 150 to cover the upper surface of the sensing magnet 200 and the side surface of the sensing magnet 200.

Meanwhile, a sensor (not shown) may be disposed in a region inside the motor 10 that faces the sensing magnet 200. The sensor can detect the position of the rotor 110 or the shaft 120 by detecting the magnetic field of the sensing magnet 200. The sensor may include a Hall sensor.

Hereinafter, the sensing magnet according to a first embodiment of the present invention will be described.

Referring to FIG. 2, the sensing magnet 200 according to a first embodiment of the present invention may have a ring-shaped cross-section. A hole 210 into which the shaft 120 is coupled may be formed in the center of the sensing magnet 200.

The sensing magnet 200 may include a plurality of unit magnets. The plurality of unit magnets may include a first unit magnet 220A and a second unit magnet 220B. The first unit magnet 220A and the second unit magnet 220B may have different polarities. For example, the first unit magnet 220A may have an N pole, and the second unit magnet 220B may have an S pole. Each of the first unit magnet 220A and the second unit magnet 220B may be provided in plural numbers and disposed alternately along a circumferential direction of the sensing magnet 200.

The sensing magnet 200 may include a slot 230. The slot 230 may be provided in plural and disposed radially with respect to the center of the sensing magnet 200. The plurality of slots 230 may be arranged to be spaced apart from each other along a circumferential direction of the sensing magnet 200. The slot 230 may have a shape that is recessed inward in a radial direction from an outer circumferential surface of the sensing magnet 200. The slot 230 may be disposed between the first unit magnet 220A and the second unit magnet 220B. In other words, the slot 230 can be understood as being formed between the N and S poles being disposed adjacent to each other.

The sensing magnet 200 may include a base portion 240 and a plurality of protruded portions 242 being protruded outward from an outer circumferential surface of the base portion 240 in a radial direction. The base portion 240 may be disposed to surround the shaft 120. The protruded portions 242 is protruded radially from an outer circumferential surface of the base portion 240, and may be provided in plural numbers and disposed to be spaced apart from each other along a circumferential direction of the base portion 240. The slot 230 may be formed between adjacent protruded portions 242. The length of the base portion 240 in a radial direction may be equal to or smaller than the length of the slot 230 in a radial direction.

The length of the slot 230 in a radial direction may correspond to the length of the sensing magnet 200 in a radial direction.

The base portion 240 has a ring-shaped cross section and may be formed as one body with the protruded portion 242.

In the present embodiment, although a state is given as an example that the first unit magnet 220A and the second unit magnet 220B are spaced apart from each other in a region in which the slot 230 is formed, and are coupled to each other in a region in which the base portion 240 is formed, it is not limited to this, and the first unit magnet 220A and the second unit magnet 220B may be disposed to be completely spaced apart in a circumferential direction. In this case, an additional slot may be formed in a region of the base portion 240 facing the slot 230 in a radial direction to space the first unit magnet 220A and the second unit magnet 220B in a circumferential direction.

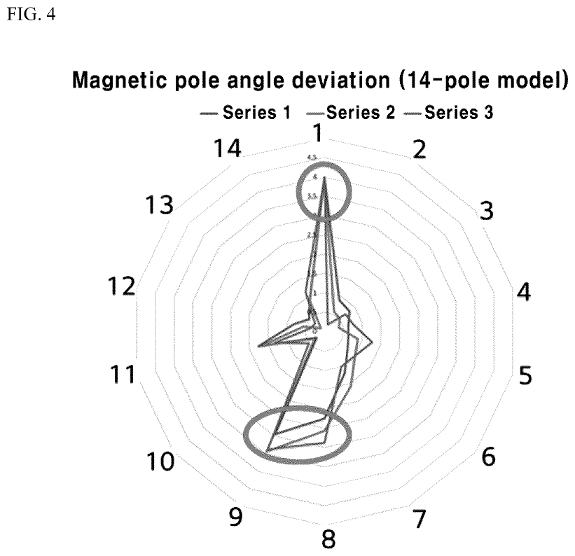

FIG. 4 is a diagram illustrating the magnetic pole deviation for each region of a sensing magnet according to the prior art.

Referring to FIG. 4, in the prior art, the pole splitting inside the sensing magnet was not uniform, resulting in magnetic pole deviation for each region, causing a problem in which the sensitivity detected from the sensor is deteriorated as the motor is driven.

However, according to the present embodiment, a polarization structure is formed through the slot 230 between regions having different polarities, thereby providing an advantage that the magnetic field in each region of the sensing magnet 200 can be formed uniformly, and thus the sensing sensitivity of the sensor according to the driving of the motor can be enhanced.

Hereinafter, a sensing magnet according to a second embodiment of the present invention will be described.

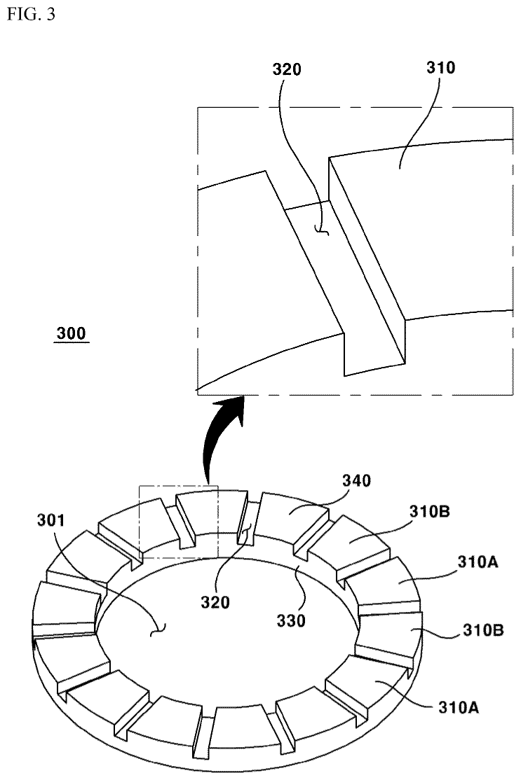

FIG. 3 is a plan view of a sensing magnet according to a second embodiment of the present invention.

Referring to FIGS. 1 and 3, the sensing magnet 300 according to a second embodiment of the present invention may have a ring-shaped cross-section. A hole 301 into which the shaft 120 is coupled may be formed in the center of the sensing magnet 300.

The sensing magnet 300 may include a plurality of unit magnets. The plurality of unit magnets may include a first unit magnet 310A and a second unit magnet 310B. The first unit magnet 310A and the second unit magnet 310B may have different polarities. For example, the first unit magnet 310A may have an N pole, and the second unit magnet 310B may have an S pole. Each of the first unit magnet 310A and the second unit magnet 310B may be provided in plural numbers and disposed alternately along a circumferential direction of the sensing magnet 300.

The sensing magnet 300 may include a slot 320. The slot 320 may be provided in plural and disposed radially with respect to the center of the sensing magnet 300. The plurality of slots 320 may be arranged to be spaced apart from each other along a circumferential direction of the sensing magnet 300. The slot 320 may have a shape that is recessed inward in a radial direction from an outer circumferential surface of the sensing magnet 300. The slot 320 may be disposed between the first unit magnet 310A and the second unit magnet 310B. In other words, the slot 320 can be understood as being formed between the N and S poles being disposed adjacent to each other.

The sensing magnet 300 may include a base portion 330 and a plurality of protruded portions 340 being protruded from the other surface of the base portion 330. The surface of the base portion 330 and the surface of the protruded portion 340 may be disposed to be stepped from each other. The protruded portions 340 are protruded from the surface of the base portion 330, and may be provided in plural numbers and disposed to be spaced apart from each other along a circumferential direction of the base portion 330. The slot 320 may be formed between adjacent protruded portions 340. The length of the protrusion 340 or the base portion 330 in a radial direction may correspond to the length of the slot 320 in a radial direction.

The length of the slot 320 in an axial direction may be equal to or smaller than the length of the base portion 330 in an axial direction. The length of the slot 320 in a circumferential direction may be smaller than the length of the protrusion 340 in a circumferential direction.

The base portion 330 has a ring-shaped cross section and may be formed as one body with the protruded portion 340.

In the present embodiment, although a state is given as an example that the first unit magnet 310A and the second unit magnet 310B are spaced apart from each other in a region in which the slot 320 is formed, and are coupled to each other in a region in which the base portion 330 is formed, it is not limited to this, and the first unit magnet 310A and the second unit magnet 310B may be disposed to be completely spaced apart in a circumferential direction. In this case, an additional slot may be formed in a region of the base portion 330 facing the slot 320 in a radial direction to space the first unit magnet 310A and the second unit magnet 310B in a circumferential direction.

In the above description, it is described that all the components constituting the embodiments of the present invention are combined or operated in one, but the present invention is not necessarily limited to these embodiments. In other words, within the scope of the present invention, all of the components may be selectively operated in combination with one or more. In addition, the terms “comprise”, “include” or “having” described above mean that the corresponding component may be inherent unless specifically stated otherwise, and thus it should be construed that it does not exclude other components, but further include other components instead. All terms, including technical and scientific terms, have the same meaning as commonly understood by one of ordinary skill in the art unless otherwise defined. Terms used generally, such as terms defined in a dictionary, should be interpreted to coincide with the contextual meaning of the related art, and shall not be interpreted in an ideal or excessively formal sense unless explicitly defined in the present invention.

The above description is merely illustrative of the technical idea of the present invention, and those skilled in the art to which the present invention pertains may make various modifications and changes without departing from the essential characteristics of the present invention. Therefore, the embodiments disclosed in the present invention are not intended to limit the technical idea of the present invention but to describe the present invention, and the scope of the technical idea of the present invention is not limited by these embodiments. The protection scope of the present invention should be interpreted by the following claims, and all technical ideas within the equivalent scope should be interpreted as being included in the scope of the present invention.

1-10. (canceled)

11. A motor comprising:
a stator;
a rotor disposed inside the stator;
a shaft coupled to the rotor; and
a sensing magnet disposed above the rotor,
wherein the sensing magnet is provided with a plurality of radial slots,
wherein the sensing magnet includes first unit magnets and second unit magnets arranged alternately along a circumferential direction,
wherein a polarities of the first unit magnet and the second unit magnet are different from each other, and
wherein the slot is disposed between the first unit magnet and the second unit magnet.

12. The motor according to claim 11, wherein the sensing magnet is coupled to a support plate, and the support plate is coupled to the shaft.

13. The motor according to claim 12, including a cover coupled to the support plate to cover the other surface of the sensing magnet.

14. The motor according to claim 13, wherein the support plate includes one surface facing the rotor and the other surface facing the cover,
wherein the other surface of the support plate includes a protruded region more protruded than the other region, and
wherein the sensing magnet is disposed outside the protruded region.

15. The motor according to claim 11, wherein the sensing magnet includes one surface facing the rotor, and
wherein the slot is formed on the other surface of the sensing magnet facing the one surface.

16. The motor according to claim 15, wherein the sensing magnet includes a base portion and a plurality of protruded portions protruded from the base portion, and
wherein the slot is disposed between the pluralities of protruded portions.

17. The motor according to claim 16, wherein the length of the slot in a radial direction is equal to or smaller than a length of the base portion in a radial direction.

18. The motor according to claim 16, wherein a length of the slot in a radial direction corresponds to a length of the base portion in a radial direction.

19. The motor according to claim 16, wherein a length of the slot in a circumferential direction is smaller than a length of the protruded portion in a circumferential direction.

20. The motor according to claim 11, wherein the slot is disposed on an outer circumferential surface of the sensing magnet.

21. The motor according to claim 16, wherein a radial length of the base portion is equal to or smaller than a radial length of the sensing magnet.

22. The motor according to claim 11, wherein an axial length of the slot is the same as an axial length of the sensing magnet.

23. The motor according to claim 11, wherein the first unit magnet and the second unit magnet are spaced apart from each other.

24. The motor according to claim 11, wherein the slot is disposed on an upper surface of the sensing magnet.

25. The motor according to claim 11, wherein the slot overlaps a boundary between the first and second unit magnets in a radial direction.

26. A motor comprising:
a stator;
a rotor disposed inside the stator;
a shaft coupled to the rotor; and
a sensing magnet disposed above the rotor,
wherein the sensing magnet includes a base portion and a plurality of protruded portions protruded from the base portion, and
wherein the plurality of protruded portions are spaced apart from each other.

27. The motor according to claim 26, wherein the sensing magnet is provided with a plurality of radial slots, and
wherein a radial length of the base portion is equal to or smaller than a radial length of the sensing magnet.

28. The motor according to claim 27, wherein an axial length of the slot is the same as an axial length of the sensing magnet.

29. The motor according to claim 27, wherein the sensing magnet includes one surface facing the rotor, and
wherein the slot is formed on the other surface of the sensing magnet facing the one surface.

30. The motor according to claim 27, wherein the slot is disposed on an upper surface of the sensing magnet.
